(19) United States
(12) Patent Application Publication
(10) Pub. No.: US 2023/0223181 A1
(43) Pub. Date: Jul. 13, 2023

(54) INDUCTOR DEVICE

(71) Applicant: Realtek Semiconductor Corporation, Hsinchu (TW)

(72) Inventors: Hsiao-Tsung YEN, Hsinchu (TW); Hung-Han CHEN, Hsinchu (TW)

(21) Appl. No.: 18/150,799

(22) Filed: Jan. 6, 2023

(30) Foreign Application Priority Data
Jan. 12, 2022 (TW) 111101313

(51) Int. Cl. H01F 27/28

(52) U.S. Cl. CPC H01F 27/2828

(57) ABSTRACT

An inductor device includes a first trace, a second trace, and a capacitor. The first trace includes a first sub-trace and a second sub-trace. The first sub-trace includes a plurality of first wires. The second sub-trace includes a plurality of second wires, wherein the first wires and the second wires are disposed on the same layer. The first wires and the second wires are disposed to each other in an interlaced manner, and located at a first corner of the inductor device. The second trace includes a third sub-trace and a fourth sub-trace. The capacitor is coupled between the first sub-trace and the third sub-trace.

### RELATED APPLICATIONS

This application claims priority to and the benefit of Taiwan Application Serial Number 111101313, filed on Jan. 12, 2022, the entire contents of which are incorporated herein by reference as if fully set forth below in its entirety and for all applicable purposes.

### BACKGROUND

### Field of Invention

The present disclosure relates to an electronic device. More particularly, the present disclosure relates to an inductor device.

### Description of Related Art

Radio frequency (RF) devices generate second harmonic, third harmonic, etc. during operation. The harmonics cause negative effect to other circuits. For example, second harmonic of 2.4 GHz circuit is near 5 GHz, and 5 GHz signal causes negative effect to system on chip (SoC).

Conventional way to solve negative effect caused by harmonics is that a filter will be disposed outside of a circuit for filtering the harmonics. However, the filter disposed outside of the circuit will affect function of the circuit and generate additional costs.

### SUMMARY

The foregoing presents a simplified summary of the disclosure in order to provide a basic understanding to the reader. This summary is not an extensive overview of the disclosure and it does not identify key/critical elements of the present disclosure or delineate the scope of the present disclosure. Its sole purpose is to present some concepts disclosed herein in a simplified form as a prelude to the more detailed description that is presented later.

One aspect of the present disclosure is to provide an inductor device. The inductor device comprises a first trace, a second trace, and a capacitor. The first trace comprises a first sub-trace and a second sub-trace. The first sub-trace comprises a plurality of first windings. The second sub-trace comprises a plurality of second windings, wherein the first windings and the second windings are disposed on the same layer. The first windings and the second windings are disposed to each other in an interlaced manner, and located at a first corner of the inductor device. The second trace comprises a third sub-trace and a fourth sub-trace. The capacitor is coupled between the first sub-trace and the third sub-trace.

Another aspect of the present disclosure is to provide an inductor device. The inductor device comprises a first trace, a second trace, a first input/output portion, and a second input/output portion. The first trace comprises a first sub-trace and a second sub-trace. The first sub-trace comprises a plurality of first windings. The second sub-trace includes a plurality of second windings, wherein the first wires and the second wires are located on a same layer, the first wires and the second wires are disposed to each other in an interlaced manner, and located at a first corner of the inductor device. The second trace comprises a third sub-trace and a fourth sub-trace. The first input/output portion is coupled to the first sub-trace and the third sub-trace. The second input/output portion is coupled to the second sub-trace and the fourth sub-trace.

Therefore, based on the technical content of the present disclosure, a plurality of wires can be disposed at corners of the inductor device of the present disclosure so as to enhance the density of the wires of the inductor, such that the inductance can be increased. Compared to the prior art, the inductance of the inductor device of the present disclosure enhances at least 50%.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 depicts a schematic diagram of an inductor device according to one embodiment of the present disclosure;

FIG. 2 depicts a schematic diagram of a portion structure of the inductor device shown in FIG. 1 according to one embodiment of the present disclosure;

FIG. 3 depicts a schematic diagram of an inductor device according to one embodiment of the present disclosure;

FIG. 4 depicts a schematic diagram of an inductor device according to one embodiment of the present disclosure;

FIG. 5 depicts a schematic diagram of an inductor device according to one embodiment of the present disclosure;

FIG. 6 depicts a schematic diagram of an inductor device according to one embodiment of the present disclosure; and

FIG. 7 depicts a schematic diagram of an inductor device according to one embodiment of the present disclosure.

According to the usual mode of operation, various features and elements in the figures have not been drawn to scale, which are drawn to the best way to present specific features and elements related to the disclosure. In addition, among the different figures, the same or similar element symbols refer to similar elements/components.

### DESCRIPTION OF THE EMBODIMENTS

To make the contents of the present disclosure more thorough and complete, the following illustrative description is given with regard to the implementation aspects and embodiments of the present disclosure, which is not intended to limit the scope of the present disclosure. The features of the embodiments and the steps of the method and their sequences that constitute and implement the embodiments are described. However, other embodiments may be used to achieve the same or equivalent functions and step sequences.

Unless otherwise defined herein, scientific and technical terminologies employed in the present disclosure shall have the meanings that are commonly understood and used by one of ordinary skill in the art. Unless otherwise required by context, it will be understood that singular terms shall include plural forms of the same and plural terms shall include the singular. Specifically, as used herein and in the claims, the singular forms “a” and “an” include the plural reference unless the context clearly indicates otherwise.

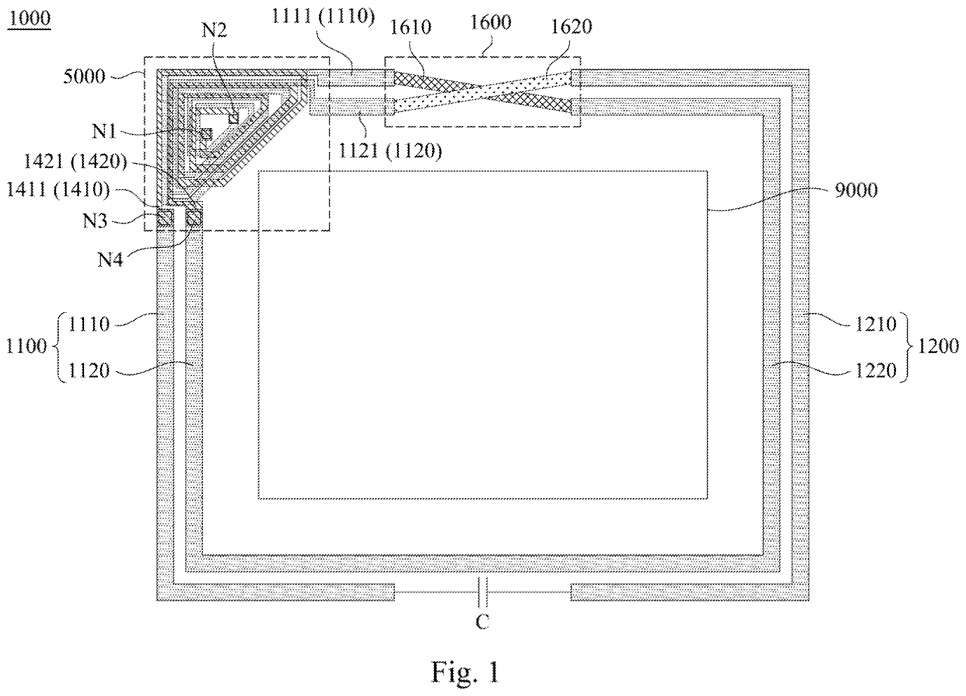

FIG. 1 depicts a schematic diagram of an inductor device 1000 according to one embodiment of the present disclosure. As shown in the figure, the inductor device 1000 includes a first trace 1100, a second trace 1200, and a capacitor C. In addition, the first trace 1100 includes a first sub-trace 1110 and a second sub-trace 1120. The second trace 1200 includes a third sub-trace 1210 and a fourth sub-trace 1220. Besides, the capacitor C is coupled between the first sub-trace 1110 and the third sub-trace 1210.

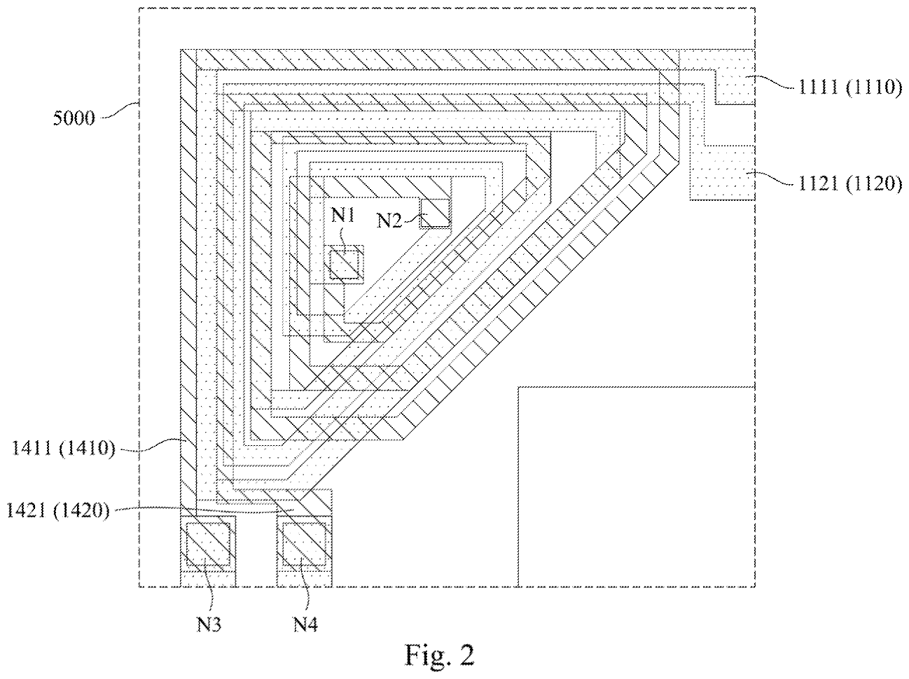

FIG. 2 depicts a schematic diagram of a portion structure of the inductor device 1000 shown in FIG. 1 according to one embodiment of the present disclosure. As shown in the figure, the first sub-trace 1110 includes a plurality of first wires 1111. The second sub-trace 1120 includes a plurality of second wires 1121. The first wires 1111 and the second wires 1121 are located on the same layer, and the first wires 1111 and the second wires 1121 are disposed to each other in an interlaced manner, and located at a first corner 5000 of the inductor device 1000. For example, the first wires 1111 are formed by winding the first sub-trace 1110, and the second wires 1121 are formed by winding the second sub-trace 1120. The first wires 1111 and the second wires 1121 are disposed to each other in an interlaced manner, for example, the sequence is that the first wire 1111, the second wire 1121, the first wire 1111, the second wire 1121, and so on. Reference is now made to FIG. 1 and FIG. 2, the first wires 1111 and the second wires 1121 are located at an upper-left corner 5000 of the inductor device 1000.

Reference is now made to FIG. 1 and FIG. 2, the first trace 1110 further includes a fifth sub-trace 1410 and a sixth sub-trace 1420. The fifth sub-trace 1410 includes a plurality of fifth wires 1411. The fifth wires 1411 are located above the first wires 1111, and coupled to the first wires 1111. For example, one terminal of the fifth wires 1411 and one terminal of the first wires 1111 are coupled at a node N1 which is located at an inner most side of the fifth wires 1411. Another terminal of the fifth wires 1411 and another terminal of the first wires 1111 are coupled at a node N3 which is located at an outer most side of the fifth wires 1411.

Besides, the sixth sub-trace 1420 includes a plurality of sixth wires 1421. The sixth wires 1421 are located above the second wires 1121, and coupled to the second wires 1121. The fifth wires 1411 and the sixth wires 1421 are disposed to each other in an interlaced manner, and located at the first corner 5000 of the inductor device 1000. For example, one terminal of the sixth wires 1421 and one terminal of the second wires 1121 are coupled at a node N2 which is located at an inner most side of the sixth wires 1421. Another terminal of the sixth wires 1421 and another terminal of the second wires 1121 are coupled at a node N4 which is located at an outer most side of the sixth wires 1421. Besides, the fifth wires 1411 and the sixth wires 1421 are located at an upper-left corner 5000 of the inductor device 1000.

In one embodiment, the first wires 1111 and the second wires 1121 are located on a first layer, the fifth wires 1411 and the sixth wires 1421 are located on a second layer, and the first layer is different from the second layer. For example, the fifth wires 1411 and the sixth wires 1421 are located above the first wires 1111 and the second wires 1121. However, the present disclosure is not intended to be limited to the structures in FIG. 1 and FIG. 2. In another embodiment, the fifth wires 1411 and the sixth wires 1421 can be disposed below the first wires 1111 and the second wires 1121 depending on actual requirements.

In another embodiment, the first wires 1111 and the fifth wires 1411 are partially overlapped. Besides, the second wires 1121 and the sixth wires 1421 are partially overlapped. In addition, from another point of views, the first wires 1111 and the sixth wires 1421 are partially overlapped. In addition, the second wires 1121 and the fifth wires 1411 are partially overlapped.

Referring to FIG. 1, the inductor device 1000 further includes a crossing connection portion 1600. The crossing connection portion 1600 is configured to couple one of the first sub-trace 1110 and the second sub-trace 1120 and one of the third sub-trace 1210 and the fourth sub-trace 1220, and configured to couple to another one of the first sub-trace 1110 and the second sub-trace 1120 and another one of the third sub-trace 1210 and the fourth sub-trace 1220. For example, the crossing connection portion 1600 can be configured to couple to the first sub-trace 1110 among the first and the second sub-traces 1110, 1120 and the fourth sub-trace 1220 among the third and the fourth sub-traces 1210, 1220, and configured to couple to the second sub-trace 1120 among the first and the second sub-traces 1110, 1120 and the third sub-trace 1210 among the third and the fourth sub-traces 1210, 1220.

In another embodiment, the crossing connection portion 1600 includes a first crossing connection element 1610 and a second crossing connection element 1620. The first crossing connection element 1610 is configured to couple to the first sub-trace 1110 and the fourth sub-trace 1220. Besides, the second crossing connection element 1620 is configured to couple to the second sub-trace 1120 and the third sub-trace 1210.

In one embodiment, an inductor 9000 can be disposed inside the inductor device 1000. However, the present disclosure is not intended to be limited to the structures in FIG. 1. In another embodiment, another shape or another type of inductor can be disposed inside the inductor device 1000 depending on actual requirements. Besides, the present disclosure is not limited to the structure as shown in FIGS. 1 and 2, and it is merely an example for illustrating one of the implements of the present disclosure.

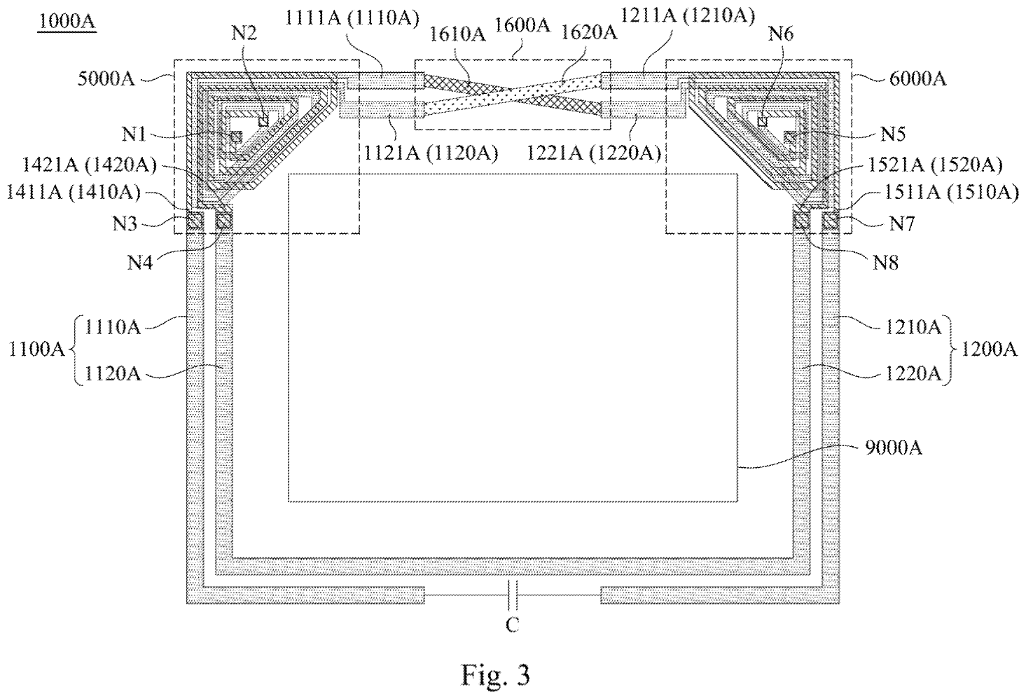

FIG. 3 depicts a schematic diagram of an inductor device 1000A according to one embodiment of the present disclosure. Compared with the inductor device 1000 in FIG. 1, the third sub-trace 1210A and the fourth sub-trace 1220A of the inductor device 1000A in FIG. 3 further includes third wires 1211A and fourth wires 1221A. As shown in the figure, the third sub-trace 1210A includes a plurality of third wires 1211A, and the fourth sub-trace 1220A includes a plurality of fourth wires 1221A. Besides, the third wires 1211A and the fourth wires 1221A are located on the same layer, and the third wires 1211A and the fourth wires 1221A are disposed to each other in an interlaced manner, and located at a second corner 6000A of the inductor device 1000A. For example, the third wires 1211A are formed by winding the third sub-trace 1210A, and the fourth wires 1221A are formed by winding the fourth sub-trace 1220A. The third wires 1211A and the fourth wires 1221A are disposed to each other in an interlaced manner, for example, the sequence is that the third wire 1211A, the fourth wire 1221A, the third wire 1211A, the fourth wire 1221A, and so on. Referring to FIG. 3, the third wires 1211A and the fourth wires 1221A are located at an upper-right corner 6000A of the inductor device 1000A.

In one embodiment, the second trace 1200A further includes a seventh sub-trace 1510A and an eighth sub-trace 1520A. The seventh sub-trace 1510A includes a plurality of seventh wires 1511A. The seventh wires 1511A are located above the third wires 1211A, and coupled to the third wires 1211A. For example, one terminal of the seventh wires 1511A and one terminal of the third wires 1211A are coupled at a node N5 which is located at an inner most side of the seventh wires 1511A. Another terminal of the seventh wires 1511A and another terminal of the third wires 1211A are coupled at a node N7 which is located at an outer most side of the seventh wires 1511A.

Besides, the eighth sub-trace 1520A includes a plurality of eighth wires 1521A. The eighth wires 1521A are located above the fourth wires 1221A, and coupled to the fourth wires 1221A. The seventh wires 1511A and the eighth wires 1521A are disposed to each other in an interlaced manner, and located at a second corner 6000A of the inductor device 1000A. For example, one terminal of the eighth wires 1521A and one terminal of the fourth wires 1221A are coupled at a node N6 which is located at an inner most side of the eighth wires 1521A. Another terminal of the eighth wires 1521A and another terminal of the fourth wires 1221A are coupled at a node N8 which is located at an outer most side of the eighth wires 1521A. Besides, the seventh wires 1511A and the eighth wires 1521A are located at an upper-right corner 6000A of the inductor device 1000A.

In one embodiment, the third wires 1211A and the fourth wires 1221A are located on the first layer, and the seventh wires 1511A and the eighth wires 1521A are located on the second layer. For example, the seventh wires 1511A and the eighth wires 1521A are located above the third wires 1211A and the fourth wires 1221A. However, the present disclosure is not intended to be limited to the structures in FIG. 3. In another embodiment, the seventh wires 1511A and the eighth wires 1521A can be disposed below third wires 1211A and the fourth wires 1221A depending on accrual requirements.

In another embodiment, the third wires 1211A and the seventh wires 1511A are partially overlapped. Besides, the fourth wires 1221A and the eighth wires 1521A are partially overlapped. In addition, from another point of views, the third wires 1211A and the eighth wires 1521A are partially overlapped. In addition, the fourth wires 1221A and the seventh wires 1511A are partially overlapped.

In one embodiment, the first wires 1111A and the second wires 1121A are disposed at a first side of the inductor device 1000A, and the third wires 1211A and the fourth wires 1221A are disposed at a second side of the inductor device 1000A. In one embodiment, the first side and the second side are located at two opposite sides of the inductor device 1000A. For example, the first wires 1111A and the second wires 1121A are disposed at a left side of the inductor device 1000A, and the third wires 1211A and the fourth wires 1221A are disposed at a right side of the inductor device 1000A.

It is noted that the present disclosure is not limited to the structure as shown in FIG. 3, and it is merely an example for illustrating one of the implements of the present disclosure.

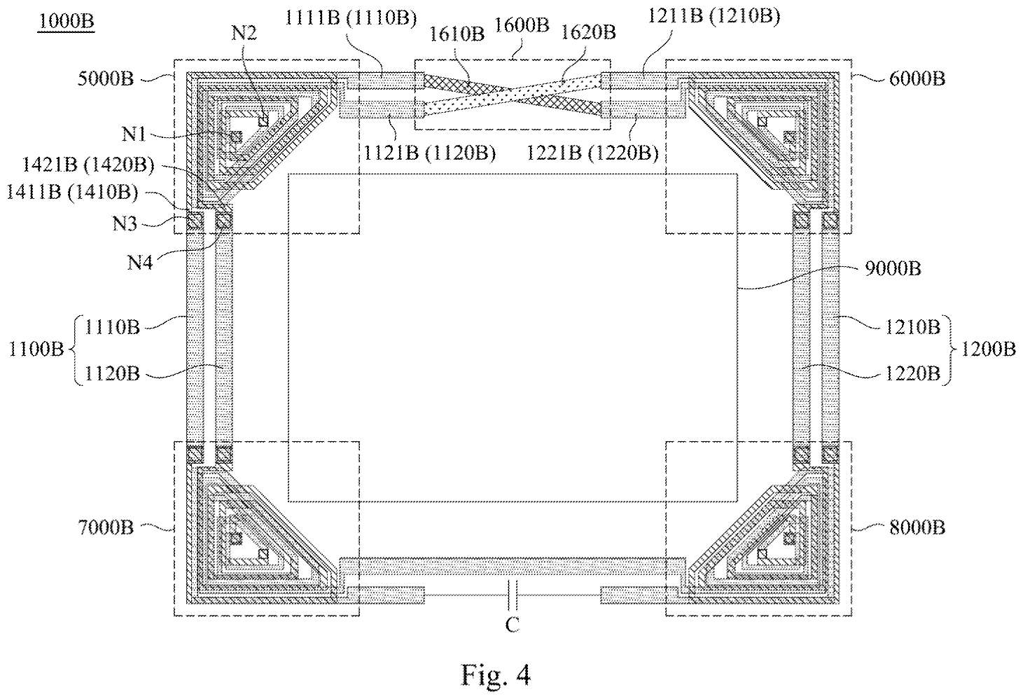

FIG. 4 depicts a schematic diagram of an inductor device according to one embodiment of the present disclosure. Compared with the inductor device 1000A in FIG. 3, the inductor device 10008 in FIG. 4 not only includes a plurality of wires which are disposed at the first corner 5000B and the second corner 6000B, but also includes a plurality of wires which are disposed at the third corner 7000B and the fourth corner 8000B. Since the disposition of the plurality of wires at the third corner 7000B and the fourth corner 8000B is similar to the disposition of the plurality of wires at the first corner 5000B and the second corner 6000B, and a detail description regarding to the disposition of the wires at the third corner 7000B and the fourth corner 8000B will be omitted herein for the sake of brevity. It is noted that the present disclosure is not limited to the structure as shown in FIG. 4, and it is merely an example for illustrating one of the implements of the present disclosure.

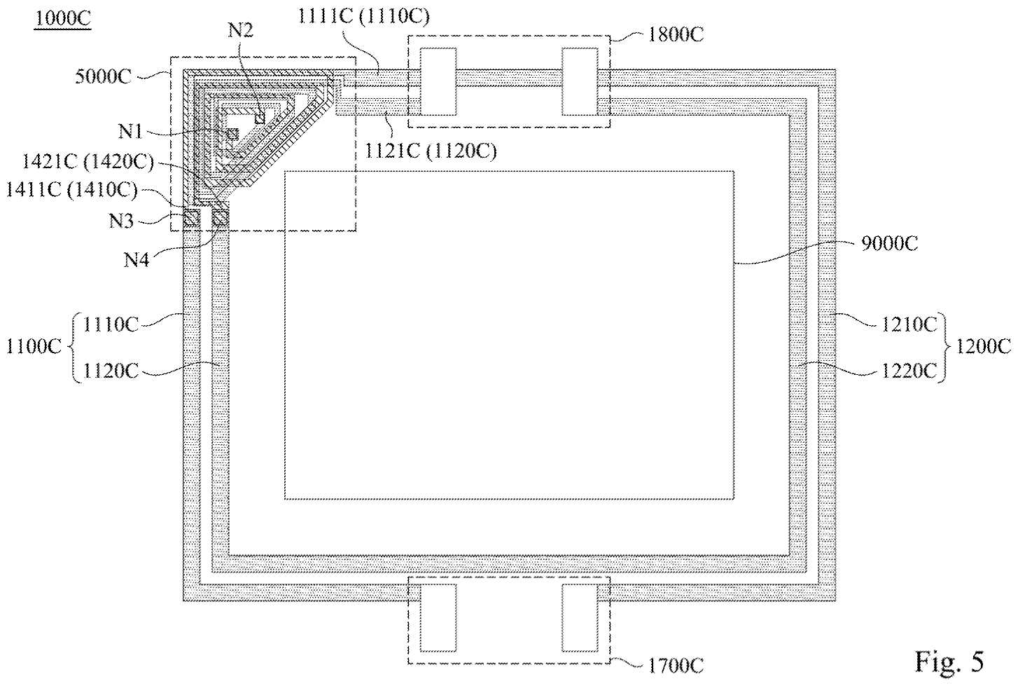

FIG. 5 depicts a schematic diagram of an inductor device 1000C according to one embodiment of the present disclosure. As shown in the figure, the inductor device 1000C includes a first trace 1100C, a second trace 1200C, a first input/output portion 1700C, and a second input/output portion 1800C. In addition, the first trace 1100C includes a first sub-trace 1110C and a second sub-trace 1120C. The second trace 1200C includes a third sub-trace 1210C and a fourth sub-trace 1220C. Besides, the first input/output portion 1700C is coupled to the first sub-trace 1110C and the third sub-trace 1210C. In addition, the second input/output portion 1800C is coupled to the second sub-trace 1120C and the fourth sub-trace 1220C.

In one embodiment, the first sub-trace 1110C includes a plurality of first wires 1111C. The second sub-trace 1120C includes a plurality of second wires 1121C. The first wires 1111C and the second wires 1121C are located on the same layer. The first wires 1111C and the second wires 1121C are disposed to each other in an interlaced manner, and located at a first corner 5000C of the inductor device 1000C. For example, the first wires 1111C are formed by winding the first sub-trace 1110C, and the second wires 1121C are formed by winding the second sub-trace 1120C. The first wires 1111C and the second wires 1121C are disposed to each other in an interlaced manner, for example, the sequence is that the first wire 1111C, the second wire 1121C, the first wire 1111C, the second wire 1121C, and so on. Besides, the first wires 1111C and the second wires 1121C are located at an upper-left corner 5000C of the inductor device 1000C.

Referring to FIG. 5, the first trace 1110C further includes a fifth sub-trace 1410C and a sixth sub-trace 1420C. The fifth sub-trace 1410C includes a plurality of fifth wires 1411C. The fifth wires 1411C are located above the first wires 1111C, and coupled to the first wires 1111C. For example, one terminal of the fifth wires 1411C and one terminal of the first wires 1111C are coupled at a node N1 which is located at an inner most side of the fifth wires 1411C. Another terminal of the fifth wires 1411C and another terminal of the first wires 1111C are coupled at a node N3 which is located at an outer most side of the fifth wires 1411C.

Besides, the sixth sub-trace 1420C includes a plurality of sixth wires 1421C. The sixth wires 1421C is located above the second wires 1121C, and coupled to the second wires 1121C. The fifth wires 1411C and the sixth wires 1421C are disposed to each other in an interlaced manner, and located at a first corner 5000C of the inductor device 1000C. For example, one terminal of the sixth wires 1421C and one terminal of the second wires 1121C are coupled at a node N2 which is located at an inner most side of the sixth wires 1421C. Another terminal of the sixth wires 1421C and another terminal of the second wires 1121C are coupled at a node N4 which is located at an outer most side of the sixth wires 1421C. Besides, the fifth wires 1411C and the sixth wires 1421C are located at an upper-left corner 5000C of the inductor device 1000C.

In one embodiment, the first wires 1111C and the second wires 1121C are located on the first layer, the fifth wires 1411C and the sixth wires 1421C are located on the second layer, and the first layer is different from the second layer. For example, the fifth wires 1411C and the sixth wires 1421C are located above the first wires 1111C and the second wires 1121C. However, the present disclosure is not intended to be limited to the structures in FIG. 5. In another embodiment, the fifth wires 1411C and the sixth wires 1421C can be disposed below the first wires 1111C and the second wires 1121C depending on accrual requirements.

In another embodiment, the first wires 1111C and the fifth wires 1411C are partially overlapped. Besides, the second wires 1121C and the sixth wires 1421C are partially overlapped. In addition, from another point of views, the first wires 1111C and the sixth wires 1421C are partially overlapped. In addition, the second wires 1121C and the fifth wires 1411C are partially overlapped.

It is noted that the present disclosure is not limited to the structure as shown in FIG. 5, and it is merely an example for illustrating one of the implements of the present disclosure.

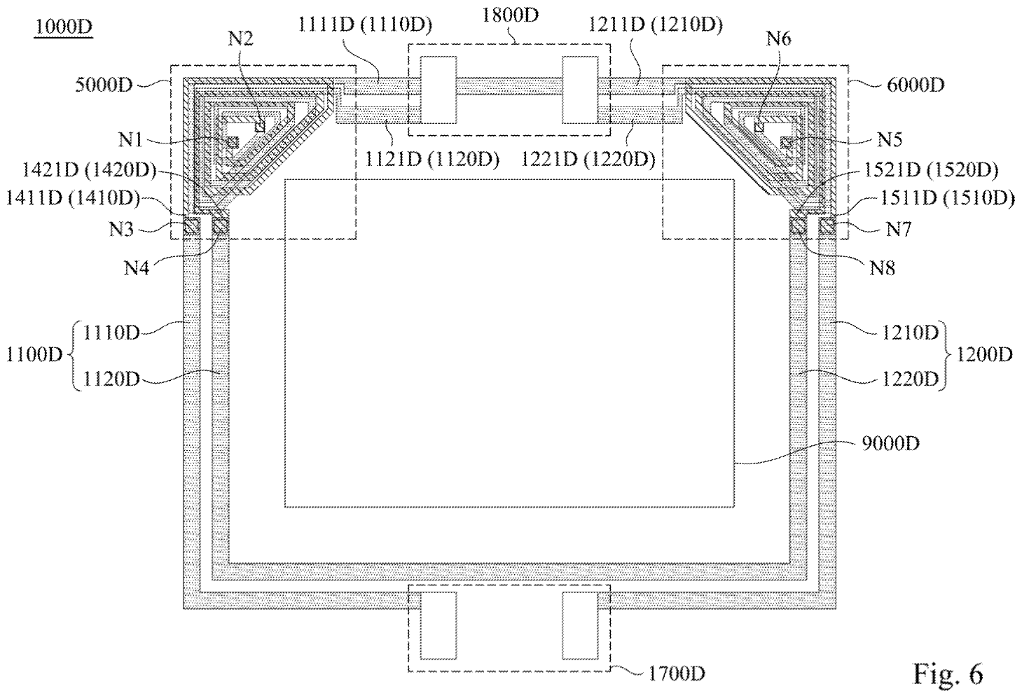

FIG. 6 depicts a schematic diagram of an inductor device 1000D according to one embodiment of the present disclosure. Compared with the inductor device 1000C in FIG. 5, the third sub-trace 1210D and the fourth sub-trace 1220D of the inductor device 1000D in FIG. 6 further include third wires 1211 D and fourth wires 1221D. As shown in the figure, the third sub-trace 1210D includes a plurality of third wires 1211D, and the fourth sub-trace 1220D includes a plurality of fourth wires 1221D. Besides, the third wires 1211D and the fourth wires 1221D are located on the same layer, the third wires 1211 D and the fourth wires 1221 D are disposed to each other in an interlaced manner, and located at a second corner 6000D of the inductor device 1000D. For example, the third wires 1211D are formed by winding the third sub-trace 1210D, and the fourth wires 1221D are formed by winding the fourth sub-trace 1220D. The third wires 1211 D and the fourth wires 1221D are disposed to each other in an interlaced manner, for example, the sequence is that the third wire 1211D, the fourth wire 1221D, the third wire 1211D, the fourth wire 1221 D, and so on. Referring to FIG. 6, the third wires 1211D and the fourth wires 1221D are located at an upper-right corner 6000D of the inductor device 1000D.

In one embodiment, the second trace 1200D further includes a seventh sub-trace 1510D and an eighth sub-trace 1520D. The seventh sub-trace 1510D includes a plurality of seventh wires 1511D. The seventh wires 1511D are located above the third wires 1211D, and coupled to the third wires 1211D. For example, one terminal of the seventh wires 1511D and one terminal of the third wires 1211D are coupled at a node N5 which is located at an inner most side of the seventh wires 1511D. Another terminal of the seventh wires 1511D and another terminal of the third wires 1211D are coupled at a node N7 which is located at an outer most side of the seventh wires 1511D.

Besides, the eighth sub-trace 1520D includes a plurality of eighth wires 1521D. The eighth wires 1521D are located above the fourth wires 1221D, and coupled to the fourth wires 1221D. The seventh wires 1511D and the eighth wires 1521D are disposed to each other in an interlaced manner, and located at a second corner 6000D of the inductor device 1000D. For example, one terminal of the eighth wires 1521D and one terminal of the fourth wires 1221D are coupled at a node N6 which is located at an inner most side of the eighth wires 1521D. Another terminal of the eighth wires 1521D and another terminal of the fourth wires 1221D are coupled at a node N8 which is located at an outer most side of the eighth wires 1521D. Besides, the seventh wires 1511D and the eighth wires 1521D are located at an upper-right corner 6000D of the inductor device 1000D.

In one embodiment, the third wires 1211D and the fourth wires 1221D are located on the first layer, and the seventh wires 1511D and the eighth wires 1521D are located on the second layer. For example, the seventh wires 1511D and the eighth wires 1521D are located above the third wires 1211D and the fourth wires 1221D. However, the present disclosure is not intended to be limited to the structures in FIG. 6. In another embodiment, the seventh wires 1511D and the eighth wires 1521D can be disposed below the third wires 1211D and the fourth wires 1221D depending on accrual requirements.

In another embodiment, the third wires 1211D and the seventh wires 1511D are partially overlapped. Besides, the fourth wires 1221D and the eighth wires 1521D are partially overlapped. In addition, from another point of views, the third wires 1211D and the eighth wires 1521D are partially overlapped. In addition, the fourth wires 1221D and the seventh wires 1511D are partially overlapped.

In one embodiment, the first wires 1111D and the second wires 1121D are disposed at a first side of the inductor device 1000D, and the third wires 1211D and the fourth wires 1221D are disposed at a second side of the inductor device 1000D. In one embodiment, the first side and the second side are located at two opposite sides of the inductor device 1000D. For example, the first wires 1111D and the second wires 1121D are disposed at a left side of the inductor device 1000D, and the third wires 1211D and the fourth wires 1221D are disposed at a right side of the inductor device 1000D.

It is noted that the present disclosure is not limited to the structure as shown in FIG. 6, and it is merely an example for illustrating one of the implements of the present disclosure.

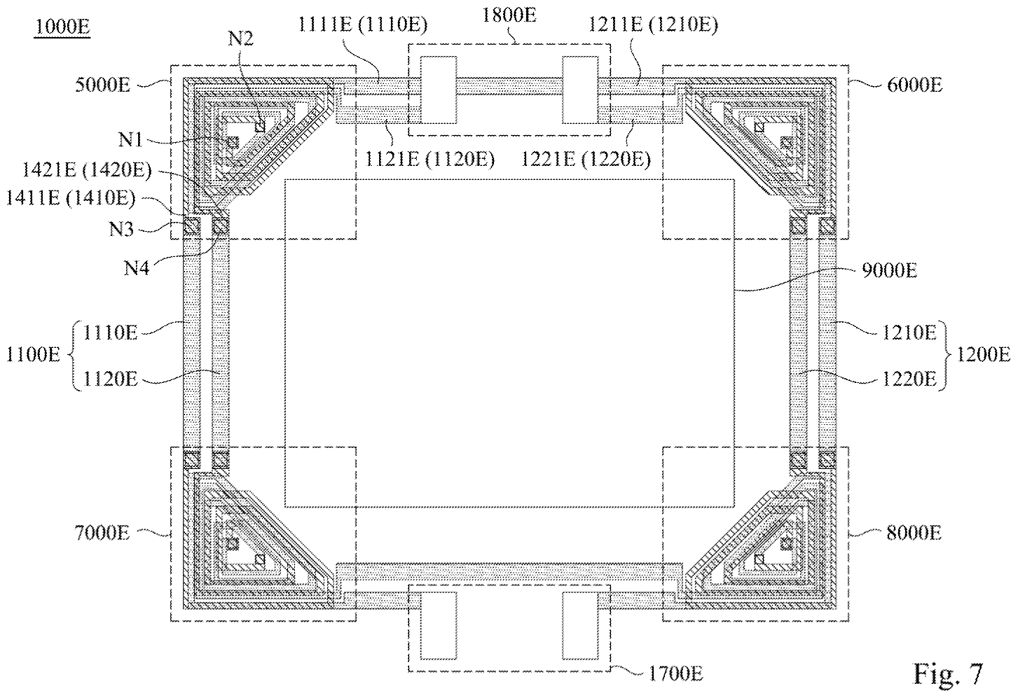

FIG. 7 depicts a schematic diagram of an inductor device according to one embodiment of the present disclosure. Compared with the inductor device 1000D in FIG. 6, the inductor device 1000E in FIG. 7 not only includes a plurality of wires which is disposed at the first corner 5000E and the second corner 6000E, but also includes a plurality of wires which is disposed at the third corner 7000E and the fourth corner 8000E. Since the disposition of the plurality of wires at the third corner 7000E and the fourth corner 8000E is similar to the disposition of the plurality of wires at the first corner 5000E and the second corner 6000E, and a detail description regarding to the disposition of the wires at the third corner 7000E and the fourth corner 8000E will be omitted herein for the sake of brevity. It is noted that the present disclosure is not limited to the structure as shown in FIG. 7, and it is merely an example for illustrating one of the implements of the present disclosure.

It can be understood from the embodiments of the present disclosure that application of the present disclosure has the following advantages. A plurality of wires can be disposed at corners of the inductor device of the present disclosure so as to enhance the density of the wires of the inductor, such that the inductance can be increased. Compared to the prior art, the inductance of the inductor device of the present disclosure enhances at least 50%.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An inductor device, comprising:
a first trace, comprising:
a first sub-trace, comprising a plurality of first wires; and
a second sub-trace, comprising a plurality of second wires, wherein the first wires and the second wires are located on a same layer, and the first wires and the second wires are disposed to each other in an interlaced manner, and located at a first corner of the inductor device;
a second trace, comprising:
a third sub-trace; and
a fourth sub-trace; and
a capacitor, coupled between the first sub-trace and the third sub-trace.

2. The inductor device of claim 1, wherein the third sub-trace comprises:
a plurality of third wires;
wherein the fourth sub-trace comprises:
a plurality of fourth wires, wherein the third wires and the fourth wires are located on a same layer, the third wires and the fourth wires are disposed to each other in an interlaced manner, and located at a second corner of the inductor device.

3. The inductor device of claim 2, wherein the first trace further comprises:
a fifth sub-trace, comprising:
a plurality of fifth wires, located above the first wires, and coupled to the first wires; and
a sixth sub-trace, comprising:
a plurality of sixth wires, located above the second wires, and coupled to the second wires, wherein the fifth wires and the sixth wires are disposed to each other in an interlaced manner, and located at the first corner of the inductor device.

4. The inductor device of claim 3, wherein the first wires and the second wires are located on a first layer, the fifth wires and the sixth wires are located on a second layer, and the first layer is different from the second layer;
wherein the first wires and the fifth wires are partially overlapped, and the second wires and the sixth wires are partially overlapped, wherein the first wires and the sixth wires are partially overlapped, and the second wires and the fifth wires are partially overlapped.

5. The inductor device of claim 4, wherein one terminal of the fifth wires and one terminal of the first wires are coupled at an inner most side of the fifth wires, and another terminal of the fifth wires and another terminal of the first wires are coupled at an outer most side of the fifth wires;
wherein one terminal of the sixth wires and one terminal of the second wires are coupled at an inner most side of the sixth wires, and another terminal of the sixth wires and another terminal of the second wires are coupled at an outer most side of the sixth wires.

6. The inductor device of claim 5, wherein the second trace further comprises:
a seventh sub-trace, comprising:
a plurality of seventh wires, located above the third wires, and coupled to the third wires; and
an eighth sub-trace, comprising:
a plurality of eighth wires, located above the fourth wires, and coupled to the fourth wires, wherein the seventh wires and the eighth wires are disposed to each other in an interlaced manner, and located at the second corner of the inductor device.

7. The inductor device of claim 6, wherein the third wires and the fourth wires are located on the first layer, and the seventh wires and the eighth wires are located on the second layer;
wherein the third wires and the seventh wires are partially overlapped, and the fourth wires and the eighth wires are partially overlapped, wherein the third wires and the eighth wires are partially overlapped, and the fourth wires and the seventh wires are partially overlapped.

8. The inductor device of claim 7, wherein one terminal of the seventh wires and one terminal of the third wires are coupled at an inner most side of the seventh wires, and another terminal of the seventh wires and another terminal of the third wires are coupled at an outer most side of the seventh wires;
wherein one terminal of the eighth wires and one terminal of the fourth wires are coupled at an inner most side of the eighth wires, and another terminal of the sixth wires and another terminal of the fourth wires are coupled at an outer most side of the eighth wires.

9. The inductor device of claim 8, wherein the first wires and the second wires are disposed at a first side of the inductor device, and the third wires and the fourth wires are disposed at a second side of the inductor device, wherein the first side and the second side are located at two opposite sides of the inductor device.

10. The inductor device of claim 9, further comprising:
a crossing connection portion, configured to couple one of the first sub-trace and the second sub-trace and one of the third sub-trace and the fourth sub-trace, and configured to couple another one of the first sub-trace and the second sub-trace and another one of the third sub-trace and the fourth sub-trace.

11. The inductor device of claim 10, wherein the crossing connection portion comprises:
a first crossing connection element, configured to couple the first sub-trace and the fourth sub-trace; and
a second crossing connection element, configured to couple the second sub-trace and the third sub-trace.

12. An inductor device, comprising:
a first trace, comprising:
a first sub-trace, comprising a plurality of first wires; and
a second sub-trace, comprising a plurality of second wires, wherein the first wires and the second wires are located on a same layer, the first wires and the second wires are disposed to each other in an interlaced manner, and located at a first corner of the inductor device;
a second trace, comprising:
a third sub-trace; and
a fourth sub-trace;
a first input/output portion, coupled to the first sub-trace and the third sub-trace; and
a second input/output portion, coupled to the second sub-trace and the fourth sub-trace.

13. The inductor device of claim 12, wherein the third sub-trace comprises:
a plurality of third wires;
wherein the fourth sub-trace comprises:
a plurality of fourth wires, wherein the third wires and the fourth wires are located on a same layer, the third wires and the fourth wires are disposed to each other in an interlaced manner, and located at a second corner of the inductor device.

14. The inductor device of claim 13, wherein the first trace further comprises:
a fifth sub-trace, comprising:
a plurality of fifth wires, located above the first wires, and coupled to the first wires; and
a sixth sub-trace, comprising:
a plurality of sixth wires, located above the second wires, and coupled to the second wires, wherein the fifth wires and the sixth wires are disposed to each other in an interlaced manner, and located at the first corner of the inductor device.

15. The inductor device of claim 14, wherein the first wires and the second wires are located on a first layer, the fifth wires and the sixth wires are located on a second layer, and the first layer is different from the second layer;
wherein the first wires and the fifth wires are partially overlapped, and the second wires and the sixth wires are partially overlapped, wherein the first wires and the sixth wires are partially overlapped, and the second wires and the fifth wires are partially overlapped.

16. The inductor device of claim 15, wherein one terminal of the fifth wires and one terminal of the first wires are coupled at an inner most side of the fifth wires, and another terminal of the fifth wires and another terminal of the first wires are coupled at an outer most side of the fifth wires;
wherein one terminal of the sixth wires and one terminal of the second wires are coupled at an inner most side of the sixth wires, and another terminal of the sixth wires and another terminal of the second wires are coupled at an outer most side of the sixth wires.

17. The inductor device of claim 16, wherein the second trace further comprises:
a seventh sub-trace, comprising:
a plurality of seventh wires, located above the third wires, and coupled to the third wires; and
an eighth sub-trace, comprising:
a plurality of eighth wires, located above the fourth wires, and coupled to the fourth wires, wherein the seventh wires and the eighth wires are disposed to each other in an interlaced manner, and located at the second corner of the inductor device.

18. The inductor device of claim 17, wherein the third wires and the fourth wires are located on the first layer, and the seventh wires and the eighth wires are located on the second layer;
wherein the third wires and the seventh wires are partially overlapped, and the fourth wires and the eighth wires are partially overlapped, wherein the third wires and the eighth wires are partially overlapped, and the fourth wires and the seventh wires are partially overlapped.

19. The inductor device of claim 18, wherein one terminal of the seventh wires and one terminal of the third wires are coupled at an inner most side of the seventh wires, and another terminal of the seventh wires and another terminal of the third wires are coupled at an outer most side of the seventh wires;
wherein one terminal of the eighth wires and one terminal of the fourth wires are coupled at an inner most side of the eighth wires, and another terminal of the sixth wires and another terminal of the fourth wires are coupled at an outer most side of the eighth wires.

20. The inductor device of claim 18, wherein the first wires and the second wires are disposed at a first side of the inductor device, and the third wires and the fourth wires are disposed at a second side of the inductor device, wherein the first side and the second side are located at two opposite sides of the inductor device.
